(19) United States
(12) Patent Application Publication
(10) Pub. No.: US 2009/0297939 A1
(43) Pub. Date: Dec. 3, 2009

(54) Bus bar and secondary battery module including the same

(76) Inventor: Jihyoung Yoon, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/457,143

(22) Filed: Jun. 2, 2009

(30) Foreign Application Priority Data
Jun. 3, 2008 (KR) 10-2008-0052270

(51) Int. Cl. H01M 2/22; H01B 5/02

(52) U.S. Cl. 429/160; 174/68.2

(57) ABSTRACT

A bus bar for a secondary battery module includes a metal plate and a chromate layer on the metal plate.

### BACKGROUND OF THE INVENTION

1. Field of the Invention

Embodiments relate to a bus bar and a secondary battery module including the same.

2. Description of the Related Art

A rechargeable secondary battery has been widely used as a power source of portable electronic devices. In addition, the secondary battery has become more important as an energy source for environment-friendly devices such as an electric vehicle and a hybrid electric vehicle (HEV), which have been proposed to solve air pollution problems caused by conventional gasoline vehicles and diesel vehicles using fossil fuels.

Small electronic devices such as a cellular phone, a camcorder, a PDA, and a notebook computer may use one or a few unit cells per one device. In contrast, middle or large-sized devices, such as an electric vehicle, require high power and large capacity, and thus use a battery module that is formed by electrically coupling a plurality of unit cells to each other.

Generally, unit cells of the battery module may be electrically coupled to each other through a bus bar. Accordingly, large current may flow through the bus bar. The bus bar may be formed to have a sufficient sectional area to prevent cutoff when the large current flows through the bus bar. The bus bar may be made of a conductive metal. The bus bar may be connected to an electrode terminal of a unit cell so as to couple the unit cells to each other electrically.

### SUMMARY OF THE INVENTION

Embodiments are therefore directed to a bus bar and a secondary battery module including the same, which substantially overcome one or more of the problems due to the limitations and disadvantages of the related art.

It is therefore a feature of an embodiment to provide a bus bar that has a low resistance and corrosion resistance by including a chromate layer formed thereon, and a secondary battery module including the same.

It is therefore another feature of an embodiment to provide a bus bar that can prevent discoloration, and a secondary battery module including the same.

It is therefore another feature of an embodiment to provide a bus bar that can be used as a power source of a hybrid electric vehicle, and a secondary battery module including the same.

At least one of the above and other features and advantages may be realized by providing a bus bar for a secondary battery module, the bus bar including a metal plate, and a chromate layer on the metal plate.

The bus bar may include an electrode withdrawing hole.

The metal plate may be formed of one or more of copper, aluminum, silver, or zinc.

The chromate layer may include a hexavalent chrome compound.

A thickness of the chromate layer may be about 0.1 to about 5 μm.

The bus bar may further include a plating layer between the metal plate and the chromate layer.

The plating layer may include one or more of nickel, tin, zinc, silver, or gold.

At least one of the above and other features and advantages may also be realized by providing a secondary battery module, including a plurality of bus bars, and a plurality of secondary batteries that are electrically coupled to each other through the plurality of bus bars, wherein at least one bus bar of the plurality of bus bars includes a metal plate, and a chromate layer on the metal plate.

A cathode terminal (+) of a first secondary battery of the plurality of secondary batteries may be electrically coupled to an anode terminal (−) of a second secondary battery of the plurality of secondary batteries through the at least one bus bar, and an anode terminal (−) of the first secondary battery may be electrically coupled to a cathode terminal (+) of a third secondary battery of the plurality of secondary batteries through a second bus bar of the plurality of bus bars, the second bus bar including a metal plate and a chromate layer on the metal plate.

The at least one bus bar and the first secondary battery may be welded to each other.

At least one of the above and other features and advantages may also be realized by providing a secondary battery module, including a bus bar, and a plurality of secondary batteries that are electrically coupled to each other through the bus bar, wherein the secondary batteries have a cathode (+) terminal with a chromate layer thereon and an anode terminal (−) with a chromate layer thereon.

The bus bar may be formed of one or more of copper, aluminum, silver, or zinc.

The secondary battery module may further include a plating layer between the cathode terminal (+) and the chromate layer thereon, and between the anode terminal (−) and the chromate layer thereon.

### BRIEF DESCRIPTION OF THE DRAWINGS

The above and other features and advantages will become more apparent to those of ordinary skill in the art by describing in detail example embodiments with reference to the attached drawings, in which:

FIG. 1A illustrates a perspective view of a bus bar for a secondary battery module according to a first example embodiment;

FIG. 1B illustrates a sectional view taken along ‘A-A’ line of FIG. 1A;

FIG. 2A illustrates a graph of resistance variation according to material and thickness of a film of the bus bar;

FIG. 2B illustrates a graph of the resistance variation of FIG. 2A by average values;

FIG. 3 illustrates a sectional view of a bus bar for a secondary battery module according to a second example embodiment;

FIGS. 4A and 4B illustrate a schematic plan and side view of a structure of a secondary battery module using the bus bar according to a third example embodiment; and

FIG. 5 illustrates a schematic side view of a secondary battery module according to a fourth example embodiment.

### DETAILED DESCRIPTION OF THE INVENTION

Korean Patent Application No. 10-2008-0052270, filed on Jun. 3, 2008, in the Korean Intellectual Property Office, and entitled: “Bus Bar and Secondary Battery Module Including the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a metal” may represent a single metal, e.g., copper, or multiple metals in combination, e.g., copper mixed with iron.

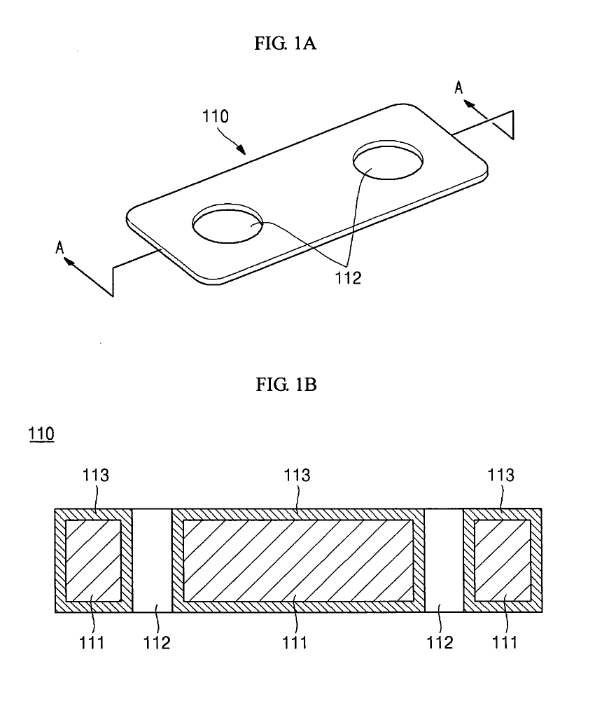

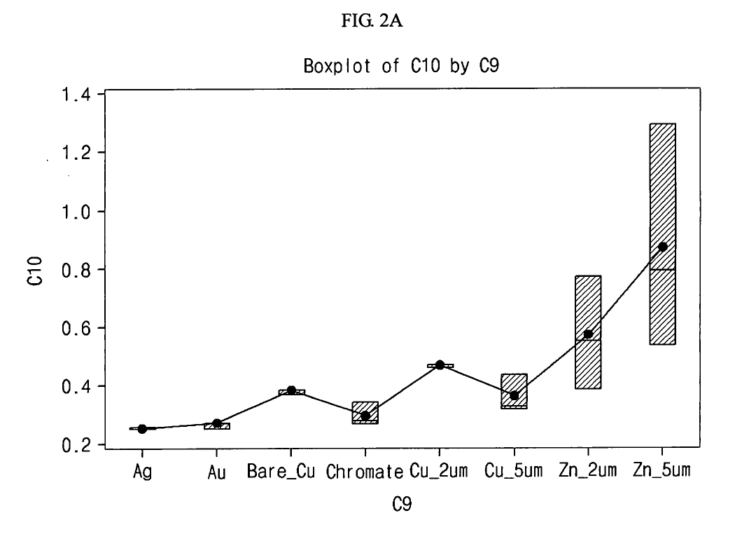

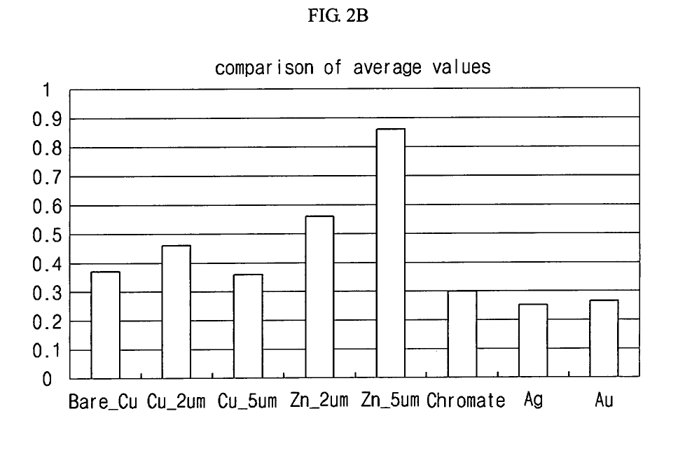

FIG. 1A illustrates a perspective view of a bus bar for a secondary battery module according to a first example embodiment, FIG. 1B illustrates a sectional view taken along ‘A-A’ line of FIG. 1A, FIG. 2A illustrates a graph of resistance variation according to material and thickness of a film of the bus bar, and FIG. 2B illustrates a graph of the resistance variation of FIG. 2A by average values.

Referring to FIGS. 1a and 1b, the bus bar 110 for the secondary battery module may include a metal plate 111 and a chromate layer 113. In addition, the bus bar 110 for the secondary battery module may further include one or more electrode withdrawing holes 112, through which an electrode may project and/or be fixed to the bus bar. As shown in FIG. 1B, the chromate layer 113 may cover the exposed surfaces of the metal plate 111, including inner sidewalls of the withdrawing holes 112. Resistance and corrosion of the bus bar may be reduced, and discoloration of the bus bar may be prevented, by this construction.

The metal plate 111 may be flat, may have a cross-sectional area of about 10 mm to about 20 mm, and may be made of one or more of copper (Cu), aluminum (Al), silver (Ag), or zinc (Zn). Copper (Cu) is desirable in consideration of material or cost.

The chromate layer 113 may be formed on the metal plate 111. The chromate layer 113 is formed by performing chromate treatment on a surface of the metal plate 111. The chromate treatment may be a metal surface-treatment that forms a film containing a hexavalent chrome (chrome (VI)) compound. The chromate treatment may include performing chemical or electrochemical treatment on copper (Cu), aluminum (Al), silver (Ag), zinc (Zn), or an alloy thereof. The treatment solution used in the chromate treatment may include chrome as a main component, and may further include an accelerant and buffer that contain one or more of sulphuric acid (H₂SO₄), nitric acid (HNO₃), or acetic acid (CH₃COOH). In the chromate treatment process, when the metal plate 111 is immersed in the treatment solution and chemically or electrochemically treated, the chromate layer 113, that is, hexavalent and trivalent complex compounds may be formed and fixed on the surface of the metal plate 111. In this time, acidity of the treatment solution may be strong, within the range of pH about 0.3 to about 1.0. The chromate treatment parameters may be dependent on concentration, temperature, and time. For example, when the concentration is fixed and the temperature is increased, the treatment time may be shortened. In addition, when the temperature is fixed and the concentration is increased, the treatment time may also be shortened. Thus, it may be desirable that the concentration, temperature, and time are properly controlled according to desired process conditions because the concentration, temperature, and time may be in a trade-off relationship with each other.

Benefits of forming the chromate layer 113 on the metal plate 111 may include those described below.

First, the chromate layer 113 may provide improved corrosion resistance to the metal plate 111, reducing or preventing corrosion thereof. The corrosion resistance may be highly improved by controlling the strength the chromate layer 113, the content of hexavalent chrome in the chromate layer 113, and the treating method and thickness of the chromate layer 113. In addition, even when the chromate layer 113 is scratched or worn, the hexavalent chrome may slowly recover itself, i.e., self-heal, to maintain corrosion resistance.

Second, the chromate layer 113 may provide a decreased electrical resistance to the bus bar. When the chromate layer 113 is formed on the metal plate 111, the contact resistance may be decreased as compared with a case where the metal plate 111 is covered with an oxidized metal layer. The contact resistance may be reduced in correspondence with a decrease of the thickness of the chromate layer 113. Accordingly, it is desirable that the thickness of the chromate layer 113 be about 0.1 μm to about 5 μm. When the thickness of the chromate layer 113 is less than about 0.1 μm, the corrosion resistance by the hexavalent chrome may be weakened and physical resistance of the chromate layer 113 itself against corrosion may be weakened. When the thickness of the chromate layer 113 is more than about 5 μm, the electrical contact resistance may be increased due to the increase of the thickness, although corrosion resistance may be further improved.

Third, the chromate layer 113 may prevent discoloration of the metal plate 111. The chromate layer 113 formed on the metal plate 111 may prevent the metal plate 111 from being contacted with air. Thus, the chromate layer 113 may prevent the metal plate 111 from being oxidized and discolored by contact with air.

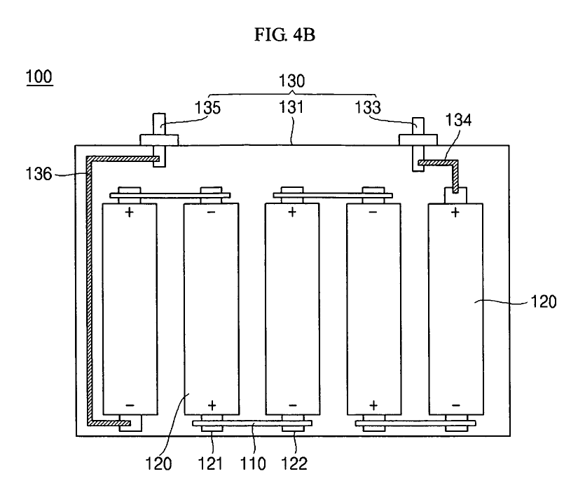

At least one electrode withdrawing hole 112 may be formed in the metal plate 111. The electrode withdrawing hole 112 may be coupled to a cathode terminal (+) 121 or an anode terminal (−) 122 of a secondary battery 120 (see FIG. 4A). Two electrode withdrawing holes may be formed in the bus bar 110 in order to be coupled to the cathode terminal (+) 121 of a first secondary battery 120 and an anode terminal (−) 122 of a second, adjacent secondary battery 120.

As described above, the bus bar 110 for the secondary battery module may include the chromate layer 113 formed on the metal plate 111 by a chromate treatment, and the metal plate 111 may be provided with the electrode withdrawing hole 112 that can be coupled to the cathode terminal (+) 121 and anode terminal (−) 122 of the secondary battery 120. Thus, according to the embodiment, the resistance of the bus bar 110 for the secondary battery module may be reduced, and corrosion and discoloration may be prevented. In addition, performance degradation of the secondary battery module 100 may be prevented by using the bus bar 110.

Table 1 below shows resistance values measured according to material and thickness of the bus bar. FIGS. 2a and 2b illustrate graphs of the measured resistance values of Table 1. The measurement results will now be explained with reference to Table 1, FIGS. 2a and 2b.

TABLE 1

| | | [Ω] | | | |
|---|---|---|---|---|---|
| | | 1^{st} | 2^{nd} | 3^{rd} | average |
| Embodiment | Chromate | 0.266898 | 0.333606 | 0.283522 | 0.294675 |
| 1 | | | | | |
| Comparison | Bare_Cu | 0.366948 | 0.366948 | 0.383647 | 0.372514 |
| example 1 | | | | | |
| Comparison | Cu_2 μm | 0.467071 | 0.467025 | 0.467048 | 0.467048 |
| example 2 | | | | | |
| Comparison | Cu_5 μm | 0.433644 | 0.316862 | 0.333556 | 0.361354 |
| example 3 | | | | | |
| Comparison | Zn_2 μm | 0.550422 | 0.383589 | 0.767255 | 0.567089 |
| example 4 | | | | | |
| Comparison | Zn_5 μm | 1.30087 | 0.53369 | 0.78386 | 0.872807 |
| example 5 | | | | | |
| Comparison | Ag | 0.250217 | 0.250179 | 0.250204 | 0.2502 |
| example 6 | | | | | |
| Comparison | Au | 0.250167 | 0.266858 | 0.266885 | 0.261303 |
| example 7 | | | | | |

Embodiment 1 shows resistance values measured after a chromate layer was formed on a copper (Cu) plate. Comparison example 1 shows resistance values of the copper (Cu) plate itself. Comparison examples 2 and 3 show resistance values measured after copper was directly plated, in two different thicknesses (2 μm and 5 μm, respectively), on a copper (Cu) plate. Comparison examples 4 and 5 show resistance values measured after zinc (Zn) was directly plated, in two different thicknesses (2 μm and 5 μm, respectively), respectively, on a copper (Cu) plate. Comparison examples 6 and 7 show resistance values measured after silver (Ag) and gold (Au) were respectively directly plated on a copper (Cu) plate.

Referring to FIG. 2A, there is almost no distribution deviation in the measured resistance values of Embodiment 1, and the range of resistance values is much narrower than the distribution deviation of Comparison examples 3 to 5. From these results, it is apparent that a bus bar 110 provided with a chromate layer according to embodiments is electrically stable. In addition, referring to FIG. 2B, Embodiment 1 represents the lowest average resistance value, except for Comparison examples 6 and 7 (silver (Ag) and gold (Au)). The average resistance values of Comparison examples 6 and 7 were lower than Embodiment 1. Accordingly, the contact resistance may be decreased more than the embodiment 1. However, silver (Ag) and gold (Au) are expensive and oxidized with the lapse of time. The results show that the electrical contact resistance can be reduced to a greater degree by forming the chromate layer on a copper (Cu) plate according to embodiments than by forming a plating of copper (Cu) or zinc (Zn) of Comparison examples 2 to 5.

Referring to the resistance values of Comparison examples 2 to 5, the resistance was increased according to the increase of the thickness of the plating layer. In addition, as shown in FIGS. 2a and 2b, the zinc (Zn) layer showed a large resistance deviation and a high average resistance as compared to copper (Cu), Embodiment 1 having the chromate layer, silver (Ag), and gold (Au) layers. This indicates that the zinc (Zn) layer was electrically unstable.

A bus bar 210 for a secondary battery module according to a second example embodiment will be explained below.

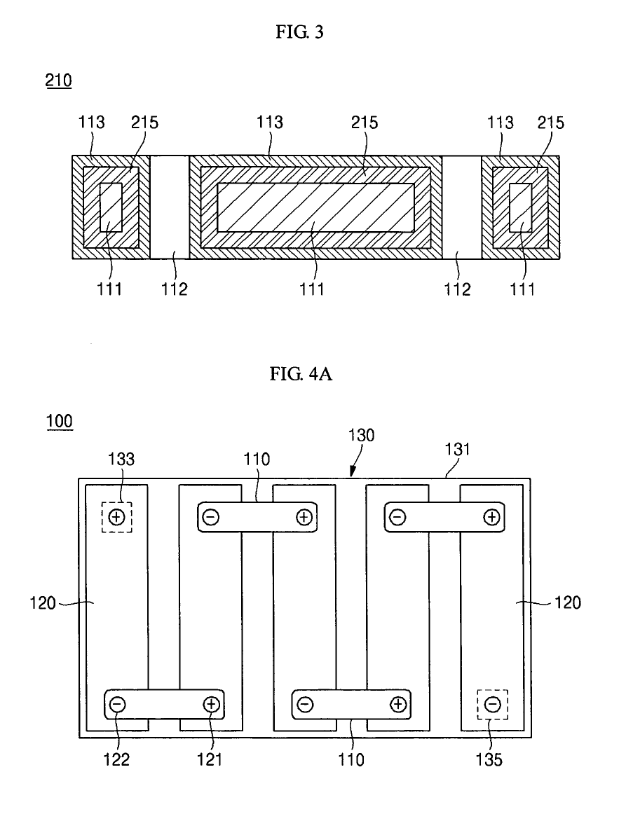

FIG. 3 illustrates a sectional view of the bus bar 210 for the secondary battery module.

The bus bar 210 shown in FIG. 3 may have the same elements as the bus bar 110 of the first embodiment, except that a plating layer 215 may be further formed between the metal plate 111 and the chromate layer 113. In the second embodiment, the plating layer 215 will be mainly explained.

Referring to FIG. 3, the bus bar 210 for the secondary battery module includes the metal plate 111, the plating layer 215, and the chromate layer 113. In addition, the bus bar 210 may further include one or more electrode withdrawing holes 112. The metal plate 111 and chromate layer 113 may be made of the materials, and perform the functions, as described above in connection with the first embodiment.

The plating layer 215 may improve contact between the metal plate 111 and chromate layer 113 where the chromate layer 113 is formed. In addition, the plating layer 215 may improve corrosion resistance of the bus bar 210. The plating layer 215 may be formed between the metal plate 111 and chromate layer 113. The plating layer may cover all surfaces of the metal plate 111, including sidewalls of the withdrawing holes 112. The plating layer 215 may be formed of one or more of nickel (Ni), tin (Sn), zinc (Zn), silver (Ag), or gold (Au).

The bus bar 210 may have a three-layered structure, which may include the plating layer 215 formed on the metal plate 111, and the chromate layer 113 formed on the plating layer 215. The bus bar 210 may provide further enhanced corrosion resistance by having the three-layered structure.

A secondary battery module 100 according to a third embodiment will be explained below.

FIGS. 4A and 4B illustrate schematic plan and side views of a structure of the secondary battery module 100 according to the third embodiment.

The secondary battery module shown in FIGS. 4A and 4B may include the bus bars 110 and/or 210 according to the above-described first and second embodiments. An electrical coupling structure between the bus bar 110 and a secondary battery 120 will be explained as a particular example.

Referring to FIGS. 4A and 4B, the secondary battery module 100 may include a plurality of bus bars 110 (and/or 210), and a plurality of secondary batteries 120. In addition, the secondary battery module 100 may include a housing 130 receiving the plurality of secondary batteries 120 inside.

The secondary battery 120 may be a rectangular or pouch type battery. The secondary battery 120 may include a cathode plate, an anode plate, and a separator (not shown) interposed between the cathode and anode plates. The anode and cathode plates and separator may be wound together in a jelly-roll type form, and sealed in a case with electrolyte. Cathode and anode active materials may be respectively coated on the cathode and anode plates. The cathode active material may be formed of, e.g., a highly stable lithium manganese compound and the anode active material may be formed of, e.g., a carbon compound.

The housing 130 may include a housing body 131, a cathode external terminal 133, and an anode external terminal 135. The housing body 131 may be formed in various types corresponding to the type of device that contains the housing body 131. Preferably, the housing body 131 is formed of an insulating material. The cathode and anode external terminals 133 and 135 may be electrically coupled to a cathode terminal (+) 121 and an anode terminal (−) 122 of the secondary battery 120, respectively. The cathode and anode external terminals 133 and 135 may be coupling members that electrically couple the cathode terminal (+) 121 and anode terminal (−) 122 to external devices.

Referring to FIG. 4A, the secondary battery module 100 may include a plurality of secondary batteries 120. The secondary batteries 120 may be serially connected to each other through the plurality of bus bars 110 (and/or 210). The cathode terminal (+) 121 and anode terminal (−) 122 project from one end of the secondary battery 120. The cathode terminal (+) 121 of one secondary battery 120 may be electrically coupled to the anode terminal (−) 122 of an adjacent secondary battery 120 through a bus bars 110 (210), and the anode terminal (+) 122 of the one secondary battery 120 may be serially connected to the cathode terminal (+) 121 of another adjacent secondary battery 120 through another bus bar 110 (210). The bus bars 110 (210) may be combined with the secondary batteries 120 by, e.g., welding.

In a secondary battery module 100 used in an electric vehicle or a hybrid electric vehicle, groups of secondary batteries 120 may be formed by serially connecting the plurality of secondary batteries 120 to each other, and then the groups of secondary batteries 120 may be connected in parallel to each other group-to-group so as to provide high power and large capacity. Accordingly, a second group of secondary batteries 120 (not shown) may be connected in parallel to the group of serially-connected secondary batteries 120 shown in FIG. 4A, where the second group of secondary batteries 120 is formed the same as the first group of secondary batteries 120 in FIG. 4A. In an implementation, multiple groups of secondary batteries 120 may be provided in the housing 130, where the cathode terminal (+) 121 of a first secondary battery 120 is connected to the cathode external terminal 133 through a cathode lead wire 134 (see FIG. 4B), and the anode terminal (+) 122 of a final secondary battery 120 is connected to the anode external terminal 135 through an anode lead wire 136 (see FIG. 4B).

Referring to FIG. 4B, the cathode terminal (+) 121 and anode terminal (−) 122 may project respectively from upper and lower parts of the secondary battery 120. When the cathode terminal (+) 121 of the first secondary battery 120 is arranged upward, a cathode terminal (+) 121 of an adjacent second secondary battery 120 may be arranged downward. By such an arrangement, the plurality of secondary batteries 120 may be provided in the housing 130 to construct the secondary battery module 100. The secondary batteries 120 may be serially connected to each other through the bus bars 110 (and/or 210). Similar to the secondary battery module 100 shown in FIG. 4A, the secondary batteries 120 may be provided in the housing 130 where the cathode terminal (+) 121 of a first secondary battery 120 is connected to the cathode external terminal 133 through the cathode lead wire 134, and the anode terminal (+) 122 of the final secondary battery 120 is connected to the anode external terminal 135 through the anode lead wire 136.

As described above, the secondary battery module 100 may include the bus bars 110, 210 having low resistance and corrosion resistance. Thus, performance degradation of the secondary battery module 100 may be prevented by using the bus bars 110, 210.

A secondary battery module 300 according to a fourth embodiment will be explained below.

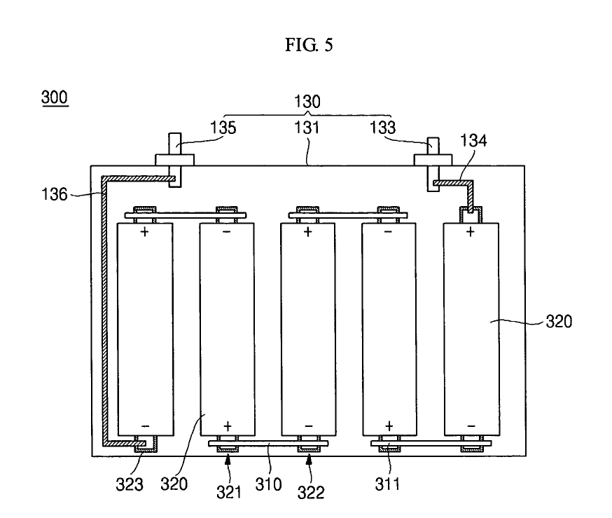

FIG. 5 illustrates a schematic side view of the secondary battery module 300 according to the fourth embodiment.

The secondary battery module 500 may have the same elements as secondary battery module 100 using the bus bar 110, 210 according to the above-described embodiments, except that a chromate layer may be formed on electrode terminals and not on bus bar 310. In the embodiment, a formation location of the chromate layer in the secondary battery module will be mainly explained.

Referring to FIG. 5, the secondary battery module 300 may include a plurality of bus bars 310 and a plurality of secondary batteries 320. The secondary battery module 300 may be formed of secondary battery groups connected in parallel to each other, where each secondary battery group is formed of serially connected secondary batteries 320.

The bus bar 310 may be flat and may include one or more electrode withdrawing holes 311 that are coupled to a cathode terminal (+) 321 and an anode terminal (−) 322 of adjacent secondary batteries 320. The bus bar 310 may be made of one or more of copper (Cu), aluminum (Al), silver (Ag), and zinc (Zn). Copper (Cu) is desirable, as described above.

In the secondary battery module 300, the secondary batteries 320 may include chromate layers 323 that are respectively formed on the cathode terminal (+) 321 and anode terminal (−) 322. The chromate layer 323 may be formed by the same process and material as the above-described chromate layer 113 and may perform the same function. In addition, a plating layer (not shown) may be interposed between the cathode terminal (+) 321 and chromate layer 323 and the anode terminal (−) 322 and chromate layer 323. The plating layer (not shown) may be formed by the same process and material as the above-described plating layer 215 and perform the same function.

In the secondary battery module 300, the chromate layer 323 may prevent corrosion of the cathode and anode electrode terminals 321 and 322, which may be made of a conductive material, and may reduce contact resistance of the electrode terminals 321 and 322 so as to prevent performance degradation of the secondary battery module 300.

As described above, embodiments may provide a bus bar that has a low resistance and corrosion resistance by including a chromate layer formed thereon, and a secondary battery module including the same. A bus bar according to embodiments may provide high conductivity and high corrosion resistance as compared to a bus bar made of copper (Cu), which may have excellent electrical conductivity but low corrosion resistance. In particular, when the bus bar made of copper is plated with nickel to prevent corrosion, electrical conductivity may also be reduced even though corrosion of the bus bar is reduced. Embodiments may also provide a secondary battery with chromate layers on the terminals thereof to provide a low resistance and corrosion resistance, and a secondary battery module including the same.

As described above, the bus bar and secondary battery module including the same according to the present invention produce the following effects. First, the resistance of the bus bar may be reduced. Second, corrosion of the bus bar may be prevented. Third, discoloration of the bus bar may be prevented.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A bus bar for a secondary battery module, the bus bar comprising:
a metal plate; and
a chromate layer on the metal plate.

2. The bus bar as claimed in claim 1, wherein the bus bar includes an electrode withdrawing hole.

3. The bus bar as claimed in claim 1, wherein the metal plate is formed of one or more of copper, aluminum, silver, or zinc.

4. The bus bar as claimed in claim 1, wherein the chromate layer includes a hexavalent chrome compound.

5. The bus bar as claimed in claim 1, wherein a thickness of the chromate layer is about 0.1 to about 5 μm.

6. The bus bar as claimed in claim 1, further comprising a plating layer between the metal plate and the chromate layer.

7. The bus bar as claimed in claim 6, wherein the plating layer includes one or more of nickel, tin, zinc, silver, or gold.

8. A secondary battery module, comprising:
a plurality of bus bars; and
a plurality of secondary batteries that are electrically coupled to each other through the plurality of bus bars, wherein at least one bus bar of the plurality of bus bars includes:
a metal plate; and
a chromate layer on the metal plate.

9. The secondary battery module as claimed in claim 8, wherein:
a cathode terminal (+) of a first secondary battery of the plurality of secondary batteries is electrically coupled to an anode terminal (−) of a second secondary battery of the plurality of secondary batteries through the at least one bus bar, and
an anode terminal (−) of the first secondary battery is electrically coupled to a cathode terminal (+) of a third secondary battery of the plurality of secondary batteries through a second bus bar of the plurality of bus bars, the second bus bar including a metal plate and a chromate layer on the metal plate.

10. The secondary battery module as claimed in claim 8, wherein the at least one bus bar and the first secondary battery are welded to each other.

11. A secondary battery module, comprising:
a bus bar; and
a plurality of secondary batteries that are electrically coupled to each other through the bus bar, wherein the secondary batteries have a cathode (+) terminal with a chromate layer thereon and an anode terminal (−) with a chromate layer thereon.

12. The secondary battery module as claimed in claim 11, wherein the bus bar is formed of one or more of copper, aluminum, silver, or zinc.

13. The secondary battery module as claimed in claim 11, further comprising a plating layer between the cathode terminal (+) and the chromate layer thereon, and between the anode terminal (−) and the chromate layer thereon.
